(19) United States
(12) Patent Application Publication
(10) Pub. No.: US 2002/0049806 A1
(43) Pub. Date: Apr. 25, 2002

(54) Parental control system for use in connection with account-based internet access server

(76) Inventors: Scott Gatz, San Francisco, CA (US); Bill Guggenheim, Palo Alto, CA (US); Tricia Lin, Los Altos, CA (US); John Robison, Campbell, CA (US); Anne Toth, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/858,855

(22) Filed: May 15, 2001

Related U.S. Application Data
(60) Provisional application No. 60/204,910, filed on May 16, 2000.

(51) Int. Cl. G06F 15/16; G06F 15/173; G06F 17/00

(52) U.S. Cl. 709/203; 709/224; 709/218; 707/104.1

(57) ABSTRACT

An access server controls use of services in an account based access server and includes a database of users, a data structure associating users identified as parents with parent accounts, users identified as children with child accounts and associating parent accounts with child accounts in family accounts. The access server includes logic for verifying parental status of a parent account with respect to a child account and logic for limiting access to a user using a child account that is associated with a family account, where such limitations are determined, at least in part, based on selections made by a user of a parent account associated with the family account.

### CROSS REFERENCES TO RELATED APPLICATIONS

The present invention claims priority from co-pending U.S. Provisional Patent Application Ser. No. 60/204,910 filed on May 16, 2000, the disclosure of which is incorporated herein in its entirety for all purposes.

### FIELD OF THE INVENTION

The present invention relates generally to access control systems, and more particularly, to an account-based access control system that allows parental supervision of information accessed by children.

### BACKGROUND OF THE INVENTION

Files or other resources on computers around the world may be made publicly available to users of other computers through the collection of networks known as the Internet. The collection of all such publicly available resources, linked together using files written in Hypertext Mark-up Language (“HTML”), is known as the World Wide Web (“WWW”).

A user of a computer that is connected to the Internet may cause a program known as a client to request resources that are part of the WWW. Server programs then process the requests to return the specified resources (assuming they are currently available). A standard naming convention has been adopted, known as a Uniform Resource Locator (“URL”). This convention encompasses several types of location names, presently including subclasses such as Hypertext Transport Protocol (“http”), File Transport Protocol (“ftp”), gopher, and Wide Area Information Service (“WAIS”). When a resource is downloaded, it may include the URLs of additional resources. Thus, the user of the client can easily learn of the existence of new resources that he or she had not specifically requested.

The various resources accessible via the WWW are created and maintained by many different people on computers around the world, with no centralized control of content. As particular types of information or images contained in this uncontrolled information collection may not be suitable for certain users, it may be desirable to selectively restrict access to WWW resources. For example, parents or school teachers might wish to have children access useful information having content appropriate with the child's age, but not obscene material (which the children may be exposed to as a result of innocent exploration of the WWW, or through the incidental downloading of a URL). Another example is the case of school teachers who would like their students to access just a particular group of resources during a class meeting. A third example is businesses that would like their employees to access only work-related resources, but not to spend their time on other WWW explorations. In general, a particular user might need to be restricted to different resources at different times, as in the case of a student restricted to different sets of resources during classes on different subjects.

Some authorities such as schools ask the users to abide by a policy statement by which they agree to restrict their exploration of the WWW, for example, by agreeing not to download obscene material. However, voluntary compliance with such a policy will not prevent the accidental downloading of resources that are not readily identifiable as forbidden or inappropriate prior to downloading and viewing.

Naturally, technical solutions such as “firewalls” are also available to limit or impede access to the WWW and Internet. These firewalls are software-based gateways that are commonly installed to protect computers on a local area network (“LAN”) from being attacked by outsiders. One effect of installing a firewall is that WWW clients can no longer directly contact WWW servers. Typically, this proves too restrictive, and users resort to “proxy servers” that are directly contacted by WWW clients. These proxy servers have special abilities to forward requests through the firewall, and thereby provide communication to and from servers on the Internet. For efficiency, a proxy server may also cache some resources locally. Current clients and proxy servers yield access to every public resource in the WWW. They are not configured to allow a particular user to request some resources, while preventing access by that user to other resources.

Some “filtering” of the available WWW resources may be effected within systems that offer indirect access. In these systems an information provider would download resources from the WWW and maintain copies of the resources. Users would access these copies. The information provider can review the resources as they are obtained from the WWW, and edit out any inappropriate or obscene material prior to making the resource available to users. A disadvantage of this scheme is that the material provided by the information provider may be out-of-date compared to the original resource on the WWW.

In an alternate scheme of “filtered” access to WWW resources, a proxy server provides a user with a menu of allowed resources that may be accessed, and users can obtain any resources that can be reached by a series of links from the menu resources. The user is only permitted to request URLs via this menu. This particular method has two disadvantages. First, many resources must be excluded from the menu because they contain links to inappropriate material, even though they themselves might be acceptable. Second, a resource may change over time to include new links that might lead to inappropriate material, and thereby provide a user with an unintended pathway of access to such material.

In still another method of “filtered” access to WWW resources, the client or proxy server checks each resource for a list of disallowed words (i.e.; obscenities; sexual terms, etc.) and shows the user only those resources that are free of these words. However, this method does not permit filtering of images and does not prohibit resources that might be inappropriate due to content other than specific words.

Yet another means of protecting users from inappropriate or obscene materials has been established by the computer and video game manufacturers. The games are voluntarily rated on the dimensions of violence, nudity/sex, and language. Although such conventions have not yet been widely adopted in the WWW, the analog would be to add such ratings to WWW resources, presumably with digital signatures to prevent forgery. A WWW client could then, if so programmed, choose not to save or display any resource that is not rated or has an unacceptable rating for the given audience. The disadvantage of this scheme is the need to convince the many people who provide useful servers (often on a non-professional or pro bono basis) to coordinate with a rating panel. All of the present systems for limiting user access to an uncontrolled public database resources, such as those available on the WWW, have obvious shortcomings.

Presently, there exists no simple means for an authority (i.e.; teacher, supervisor, system administrator, parent, etc.) to selectively control WWW access by one or more users to a varying degree, without significantly impairing the users' ability to communicate with the Internet. For example, an authority figure might desire that each account under its control, but having access to the Internet, have the ability vary the degrees of access for each of the sub-account holders, depending on the subservient entity's needs. A parent, for example, might deem that its twelve year old child require more or less access than its eight year old child. The desired flexibility in each controlled child account is difficult especially if the particular authority (i.e., parent) wishing to exert such control has few computer skills with respect to the management of information/services networks.

Thus, there is a need to overcome the aforementioned shortcomings of the present systems and to establish an apparatus and technique to provide a dominant entity, such as a parent, employer, etc., with the means to filter out and block access to unauthorized content available to a subservient entity and associated account, such as a child, employee, etc. Furthermore, there is also a need to provide a means to vary the degree of access to content available to holders of such subservient accounts, such as chatrooms, message boards, auctions, etc.

### SUMMARY OF THE INVENTION

The present invention provides an account based access control system allowing the holder of one account to control the ability of one or more other account holders to access information in an information network. Thus, it is possible for parents to establish parental accounts that can be used to control the access of their children (having child accounts) to information provided over the Internet. In effect, the parent creates a “family” account with the online server. The server includes logic and data storage that allows the server to track account identifiers (IDs) for each child in the family. With the family account, a parent that controls the family account (the “controlling parent”) can add a child to the family account with a new child account, attach an existing child account to the family account, modify a child's password, account information or other information (e.g., preferences, stored items) saved at the online system in association with a specific account, modify their child's email block lists, friend “buddy” lists and instant message ignore lists, or sign in as the child in order to be aware of and modify any aspect of the child's account. It should be understood that a “parent-child” relationship as described herein is not only familial as to human beings, but also is taxonomic as to hierarchical arrangement of accounts.

In one embodiment of the present invention, an access server controls use of services in an account based access server and includes a database of users, a link table associating users identified as parents with parent accounts, users identified as children with child accounts and associating parent accounts with child accounts in family accounts. The access server includes logic for verifying parental status of a parent account with respect to a child account and logic for limiting access to a user using a child account that is associated with a family account, where such limitations are determined, at least in part, based on selections made by a user of a parent account associated with the family account.

A further understanding of the nature and the advantages of the inventions disclosed herein may be realized by reference to the remaining portions of the specification and the attached drawings.

### BRIEF DESCRIPTION OF THE DRAWINGS

FIG. 1 is a block diagram of a data network including an on-line account-based access server constructed in accordance with the present invention;

FIG. 2 is a detailed block diagram of the account-based access server of FIG. 1;

FIG. 3 shows an exemplary data structure to link accounts in accordance with the present invention;

FIG. 4 illustrates exemplary family accounts having data for use by an on-line account-based access server in accordance with the present invention;

FIG. 5 illustrates exemplary computer files stored in a database having data for use by an on-line account-based access server in accordance with the present invention;

FIG. 6 depicts a user interface configuration showing an example of how a user identifier is employed to verify authorization to access an account;

FIG. 7 illustrates an exemplary screen display for providing verification;

FIG. 8 illustrates an example of the type of information used to provide verification;

FIG. 9 depicts a user interface configuration showing an example of how a user identifier is employed to verify authorization to access a family account;

FIG. 10 shows an exemplary user interface wherein a user is presented with preferences according to an embodiment of the present invention;

FIG. 11 shows an exemplary screen display to provide account-specific and secondary verification information according to the present invention;

FIG. 12 shows another exemplary screen display to provide account-specific and secondary verification information according to the present invention;

FIG. 13 shows another exemplary screen display to provide account-specific and secondary verification information according to the present invention;

FIG. 14 illustrates an exemplary screen display presented to an unauthorized user attempting to modify a child account's associated public profile;

FIG. 15 illustrates an exemplary screen display presented to an unauthorized user attempting to access a message board according to an embodiment of the present invention;

FIG. 16 illustrates an exemplary screen display presented to an unauthorized user attempting to access an Internet instant messenger service according to one embodiment of the present invention;

FIG. 17 illustrates another exemplary screen display presented to an authorized user of a child account upon accessing an Internet instant messenger service according to an embodiment of the present invention;

FIG. 18 shows an exemplary user interface presented to an unauthorized user of a child attempting to create a sub-account linked to the child account according to an embodiment of the present invention; and

FIG. 19 shows another exemplary user interface presented to an unauthorized user of a child attempting to create a new unrestricted account according to an embodiment of the present invention.

### DESCRIPTION OF THE SPECIFIC EMBODIMENTS

Detailed descriptions of the embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

In one embodiment of a parental control system for use with account-based access systems, a parental account is linked with a child account in an account control system. For example, a parent might set up a Yahoo! account, assist their child with setting up a Yahoo! account and have the two accounts linked.

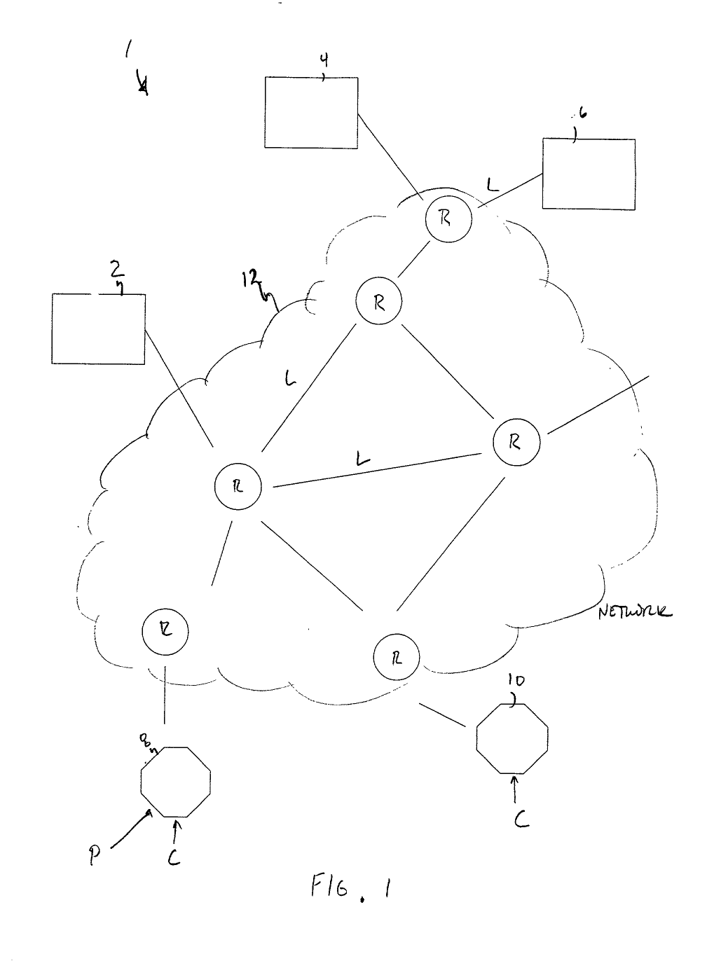

FIG. 1 is a block diagram of a data system 1 including an on-line account-based access server 2 constructed in accordance with the present invention. The data network comprises addressable routers (R) and interconnecting data links (L) forming a communications network allowing information to be transmitted between various network entities.

The data network provides the communication means, such as physical inter-connective links comprising copper wire, fiber optic cable, or the like, for transmitting and receiving signals. Wireless communication means, such as radio waves or the like, are also understood to provide means to transfer information from a source to a destination.

As is well known in the art of network communications, data networks are configured to communicate electrical information, such as a computer data signal comprising data (e.g., binary data bits) superimposed upon a radio or any other carrier wave. A person having ordinary skill in the are would appreciate that a carrier wave is electromagnetic energy propagated from a source by radiation, optical or conduction waves and is suitable for embodying an information-bearing signal, such as a computer data signal. In one embodiment, a carrier wave behaves, or is modulated, according to a network protocol, such as or Ethernet, IEEE 1394, TCP/IP, or any other communication protocol, so as to include computer data information.

The carrier wave can be, for example, a direct current, an alternating current, or a pulse chain. In modulation of the carrier wave, it may be processed in such a way that its amplitude, frequency, or some other property varies so as to embody data for transfer.

The system 1 includes information content servers 4, 6, which provide information content to users of the network. Client computer devices 8, 10 provide a way for users to access the data network. For example, the client systems are Internet-connectable computers (desktop computers, laptop computers, palm-sized computers, wearable computers, set-top boxes, imbedded TCP/IP clients, and the like). The client systems are shown for clarity, however any type of client system that allows access to the system 1 may be utilized with the present invention, and so, specific details of the client systems will not be provided herein.

In one embodiment, access server 2 is the server system operated at the URL www.yahoo.com and client-server system 1 is part of the global internetwork of networks generally referred to as the “Internet” 12, where underscores denote “dots” of a hypertext link. The client system 8 includes a browser or other HTTP (HyperText Transport Protocol) client that is used to provide a user with HTTP access to the Internet 12 and the collection of documents served by HTTP servers that is generally referred to as the “World Wide Web,” “WWW,” or simply “the Web.”

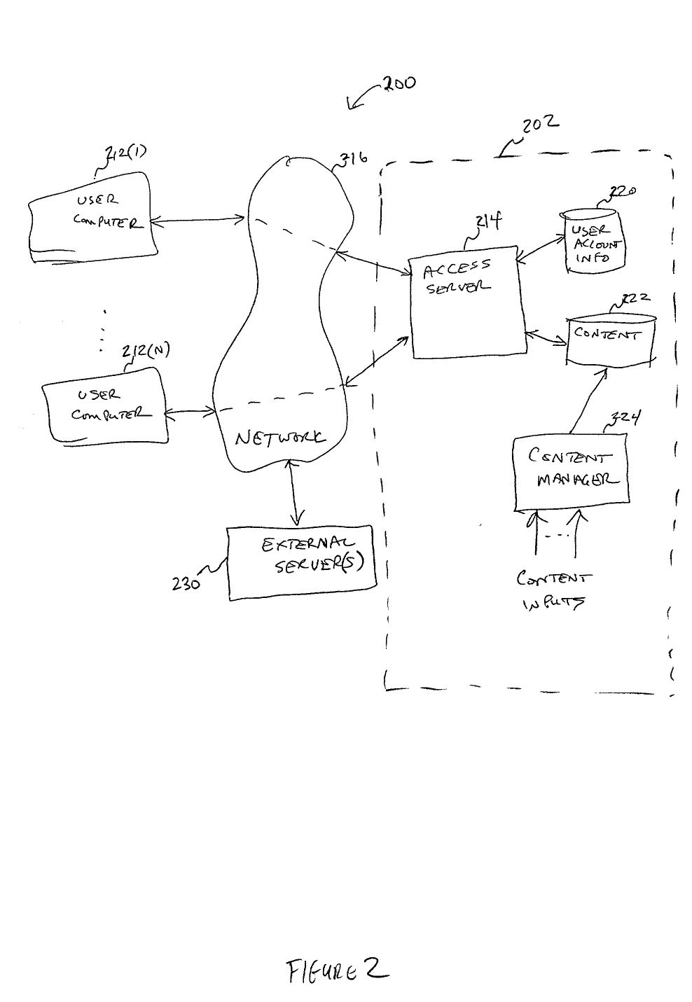

FIG. 2 illustrates an exemplary access server system configured to operate within system 200 in accordance with the present invention. Server system 202 includes access server 214, which is coupled to user account database 220 and content database 222 and responds to one or more requests for access to resources available at one or more external servers 230 by user 212 (e.g., client). Access server 214 is configured to reliably pass data using the TCP/IP (Transport Control Protocol/Internet Protocol) via the Internet 216 and other and computers network systems from a source node (e.g., user, or client) to a destination node (e.g., web, or access server). A variety of higher level protocols is used on top of TCP/IP to transport objects of digital data, the particular protocol depending on the nature of the objects. For example, hypertext documents and their associated effects are transported using the Hypertext Transport Protocol (HTTP).

In this specific example, HTTP client 212 is a browser, but other HTTP clients, such as back-end processors, could be used instead of a browser. Also, it should be understood that system 200 could be implemented with Internet 216 replaced with an alternate communications channel between HTTP client 212 and access server 214. Furthermore, it should be understood that while access server 214 is an HTTP server, it can handle requests using an entirely different protocol, so long as the different protocol is understood by HTTP client 212 or its substitute. For brevity, only two HTTP clients are shown to be configured to provide a request and to receive a response, but it should be understood that in practice many clients will be interacting with access server 214 substantially simultaneously, each with one or more access requests. In fact, if warranted, the tasks of access server 214 might be spread over multiple machines. If the tasks are spread over multiple machines, the preferred arrangement is to have the multiple machines presented to the clients as a single logical machine, to simplify client access. Furthermore, external servers 230 represents at least one external server configured to provide web pages to user 212, wherein it should be understood that in practice many external servers 230 will be interacting with user 214 substantially simultaneously.

As shown in FIG. 2, access server 202 connects a user 212 using computer devices 8 of FIG. 1 to content databases 222 and access server 214 uses and accesses user data from a user account database 220. It should be understood that databases 220 and 222 can be embodied in many different forms of data structures, such as relational tables maintained by a relational database management system or text files containing data in predetermined formats.

In the specific implementation described above, content databases 222 contain data representing content such as news, stock quotes, directory information, weather, interuser messages (i.e., Internet instant messaging services, such as Yahoo! Messenger), notes, calendar entries, etc. that a user might want to view and that are maintained by a site such as www.yahoo.com. As shown in FIG. 2, content for content databases 222 is provided by a content manager 224 based on content inputs to content manager 224. The content might include references (e.g., links, such as hypertext links) to external data, i.e., data not maintained or controlled by the operator (not shown) of access server 214. As is well known in the art of hypertext browsing, content may include links and when those links are “followed” by the browser, the browser context is transferred to the site of the followed link. A link found in the content of content databases 222 might reference an external web page found on, for example, one or more external servers 230. “Web pages” as described herein refer to a single hypertext document which forms part of a web site, where “web site” refers to a collection of one or more web pages which are controlled (i.e., modifiable) by a single entity or group of entities, such as content manager 224, working in concert to present a site on a particular topic. Such web pages include, for example, at least one predetermined control for providing the user a means to select preferences indicated on the user interface. The predetermined control might be implemented as a hypertext link, or an equivalent substitute.

Exemplary user account database 220 includes a collection of information where the information is organized such that data can be quickly accessed and retrieved. Each database, or repository, is organized by fields, records, and files. A field is a single piece of information; a record is one complete set of fields; and a file is a collection of records. For example, a telephone book is analogous to a file. It contains a list of records, each of which consists of three fields: name, address, and telephone number. Alternatively, each repository is configured to include a hypertext database, which is well known in the art of database management systems. Such repositories include any object (i.e., a piece of text, a picture, audio or video) that is linked to any other object. The exemplary repositories include hypertext databases, which are particularly useful for organizing large amounts of disparate information.

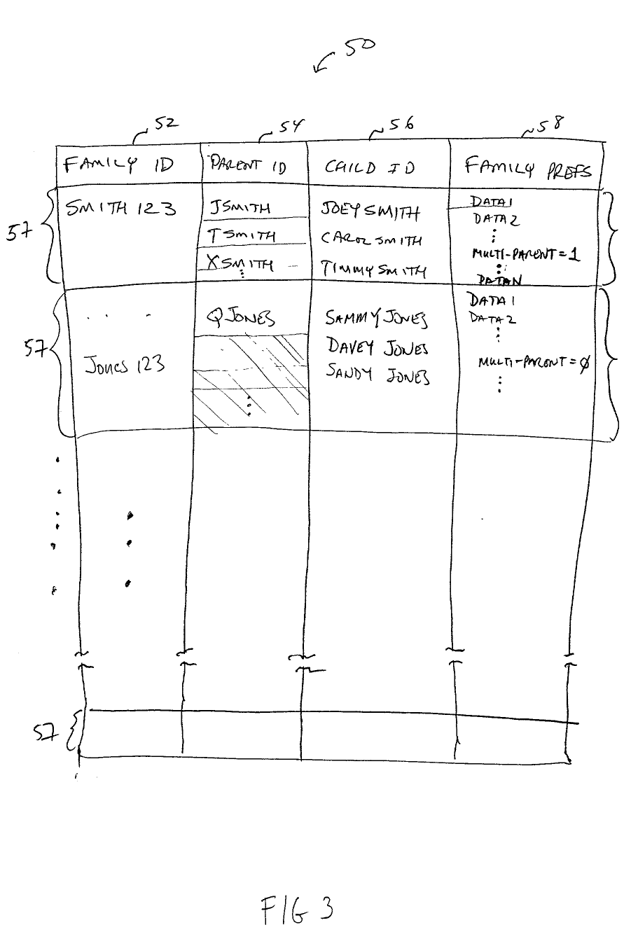

More specifically, user account database 220 is configured to store and to provide access to data in a data structure, such as shown in FIG. 3. In one embodiment of the present invention, user account database 220 includes a large number of records 57 in a table data structure associated with family account identifier 52, parent identifiers 54 for each parent (or equivalent) of the family, and/or child identifiers 56 for each child (or equivalent) of the family and preferences. Each record 57 includes other data elements 58 specific to the family account. Such data elements include user name, address, parent-child linkages, if any, and user-selected preferences, such as news topics to view, stocks to follow, and any other kind of information available from the Internet or otherwise. In the case of accounts identified as child accounts, the user account database might also contain records of what was viewed by the user of the child account, to allow parental monitoring of such activity. The data elements also might be an alpha-numeric string of information, such as a telephone number, or it might be a file having a large amount of data. A data element 58 also might be a logical flag, or it might be a pointer (e.g., link or URL) that refers to another file, or web page, containing information of interest to the account owner. Each exemplary data element is configured to be stored in one or more data field or file.

In a specific embodiment, user computer system or device 212 of FIG. 2 includes basic hardware components suitable for practicing the present invention and is coupled electrically to a network 216. Such a computer system 212 includes display having display screen, and standard computer components (not shown) such as a disk drive, CDROM drive, display adapter, network card, random access memory (RAM), central processing unit (CPU), and other components, subsystems and devices.

Also, user input devices such as mouse having buttons and keyboard (not shown) are used to input data and information specific to each account of the present invention. Other user input devices such as a trackball, touch-screen, digitizing tablet, etc. are within the scope of the present invention. In general, the computer system is illustrative of but one type of computer system, such as a desktop computer, suitable for use with the present invention. Computers can be configured with many different hardware components and can be made in many dimensions and styles (e.g., laptop, palmtop, pentop, server, workstation, mainframe, or the like). Computers and computing devices described herein include wireless telephones and any other electronic device having the ability to process and communicate information. Any hardware platform suitable for performing the processing described herein is suitable for use with the present invention.

Additionally, the above-mentioned display, or any other user output device, is coupled to a central processing unit (“CPU”) of the user computing system to provide the account owners with the means, such as a user interface, in which to configure the owner's respective accounts.

FIG. 3 illustrates how data elements might be used according to one embodiment. Using a data element 58, a family account might be configured to permit a child account to be linked to more than one account having parental control over the child account (i.e., multiple child-to-parent links). That is, if the Multi-Parent data element is set to “one,” then the family account will permit multiple child-to-parent links. For example, the Smith family would have a family account with a parental identifier 52 of Smith 123 associated with a record 57. Each child, Joey Smith, Carol Smith and Timmy Smith, has a child account associated with child identifiers 56. Since the Smith family account has been configured as Multi-Parent account, each parent (i.e., holders of parental accounts) JSmith, TSmith and XSmith will have access to each of the child accounts to monitor and to control the accounts. In contrast, the Jones family account has its Multi-Parent data element set to “zero,” thus will permitting only one child-to-parent link. That is, only QJones has access to the child accounts of Sammy Jones, Davey Jones, and Sandy Jones.

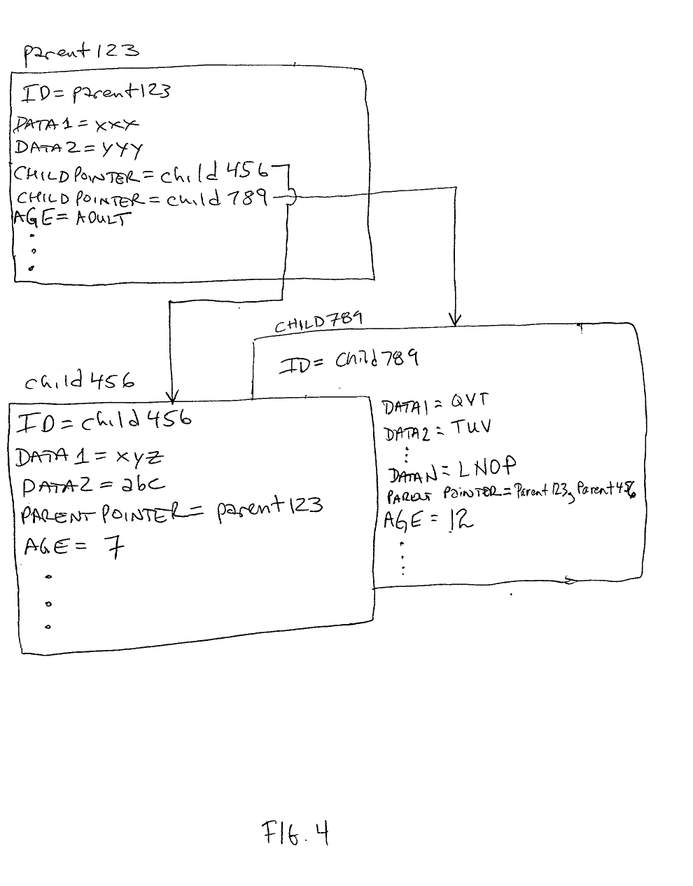

FIG. 4 depicts exemplary parent and child accounts in accordance with a specific embodiment of the present invention. Each exemplary account might be implemented as a file and includes data representing information used to control the account operation (including access) as well as information in which the account holder wishes to retain and to use. As shown, a parent identified as Parent123 has an account that includes many data elements like “XXX” as a data element, for example. The parent account also includes one or more child pointers, wherein each pointer is used to link the parent account to one or more child accounts.

Each child account, such as Child456 and Child789, includes many data elements and also include at least one parent pointer to link the respective child account to one or multiple parent accounts. Suppose Child789 account has been established as multi-parent child account. That is, Child789 account includes both Parent123 and Parent456 (not shown) as parent pointers. Thus, Parentl23 and Parent456 have the ability to access and to control the configuration of account Child789.

In contrast, suppose Child456 has been created by the parent as a non-multi-parent family account, the child account would have only a single parent pointer (i.e., Parent123). That is, only one parent (associated with account Parent123) in the household need take responsibility for managing the family account, such as updating information and/or changing passwords.

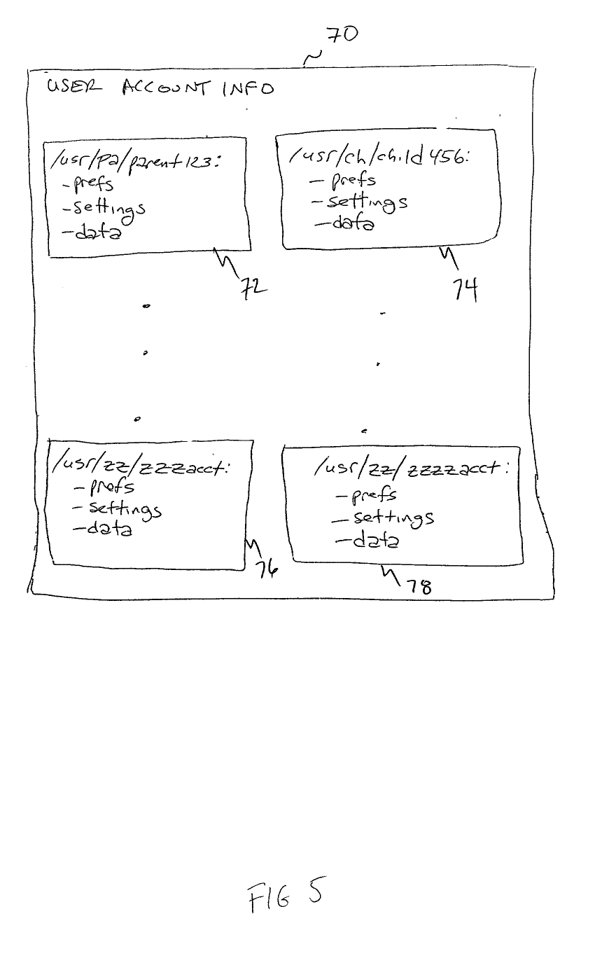

FIG. 5 illustrates user account information 70 that might be stored in the user account information database 220 of FIG. 2. Each parent accounts 72 and 76 include each of the parents' data, settings, preferences, etc. Each of the child accounts 74 and 78 include each of the children's data, settings, preferences, etc., as determined by the respective parent and as well as each of the children.

Hence, by using the account control system, one or more parent (or more precisely, the holder of the parental account) can control the access and settings of the user of the child account as well as control selected preference settings of the child account. For example, the parent can grant permission for the child to use the online services provided with the child account, control the information the child shares with others using the online services and can maintain and monitor the child account on an ongoing basis.

The account control system tracks the parent-child ties, for example, with a table of links shown in FIG. 3 between a parent account and a child account. The account control system accommodates non-multiple and multiple parent-to-child links. Non-multiple child-to-parent (i.e., a child is not permitted to link to more than one parent account) links allow a parent to oversee the accounts of more than one child, whereas multiple parent-to-child links allow more than one parent to oversee the account of a given child. Of course, while the typical arrangement might be for two parents to oversee the accounts of one or more of their children, the system is not so limited and more than two parental links can be accommodated to handle guardians, step-parents, and any other arrangement wherein two or more adults are overseeing the activities of a child. While the system is used as described herein for parents to oversee a child's activities, the system can be adapted for other uses, such as a teacher monitoring the activities of students or employers monitoring the activities of employees, or any other application where an entity requires control over subservient accounts.

The following discussion relates to the use of a user interface in practicing a specific embodiment of the present invention. To establish a child account, a parent must first establish an account, such as a MyYahoo! account.

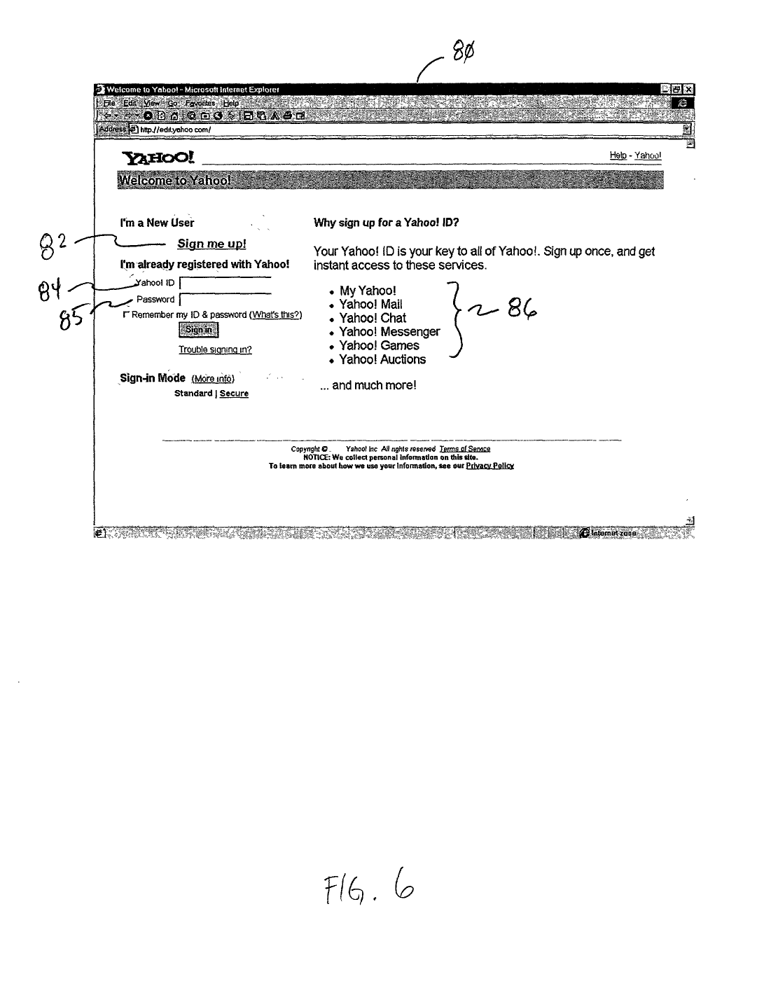

FIG. 6 shows an exemplary user interface 80 presented to a user seeking to gain access to a variety of content, services or web sites 86 provided by, for example, a web portal, an internet service provider, or the like. As a registered user, an account owner has access to email, chatrooms, Internet messaging services, games, auctions, etc. However, not all content 86 is appropriate for all users, especially younger users. Hence, a user identifier 84 and/or password 85 is required to access such content 86.

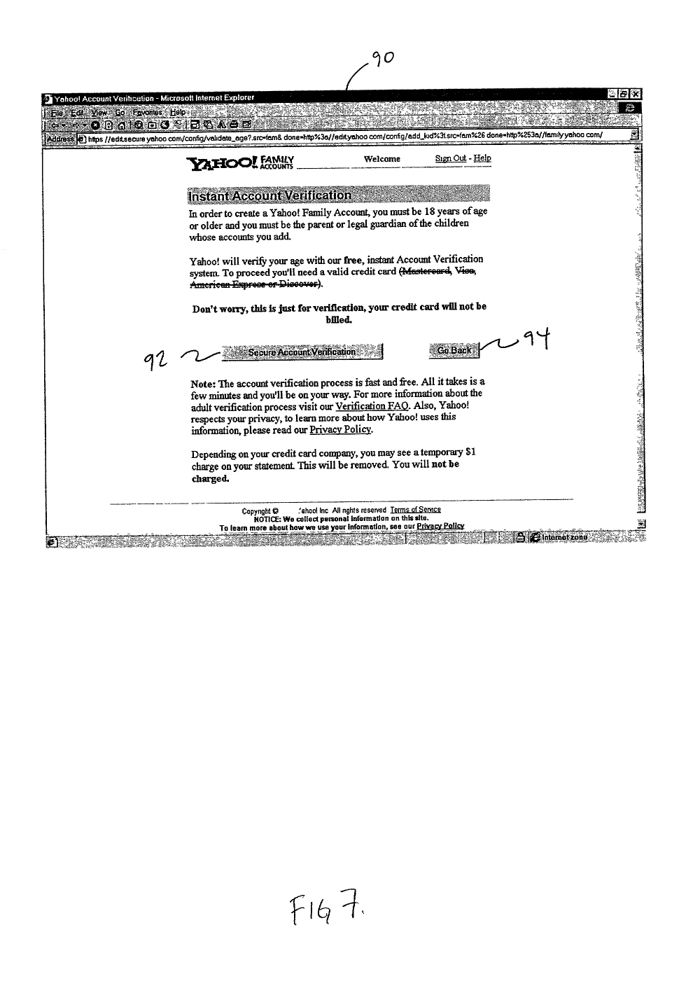

FIG. 7 shows a user interface 90 presented to a user to verify that the user is meets a minimal requirement for unrestricted account ownership, such as at least a minimal age of eighteen years old. If the user seeks to establish meeting the minimal requirements, the user might select to verify account control requirements 92 over a secure network connection using, for example, SSL (Secure Socket Layer) or the like. If the user chooses not to proceed, the user selects to go back 94. Such a verification might be required when initially establishing an account as well as when using the established account to later perform parent control functions over a child account.

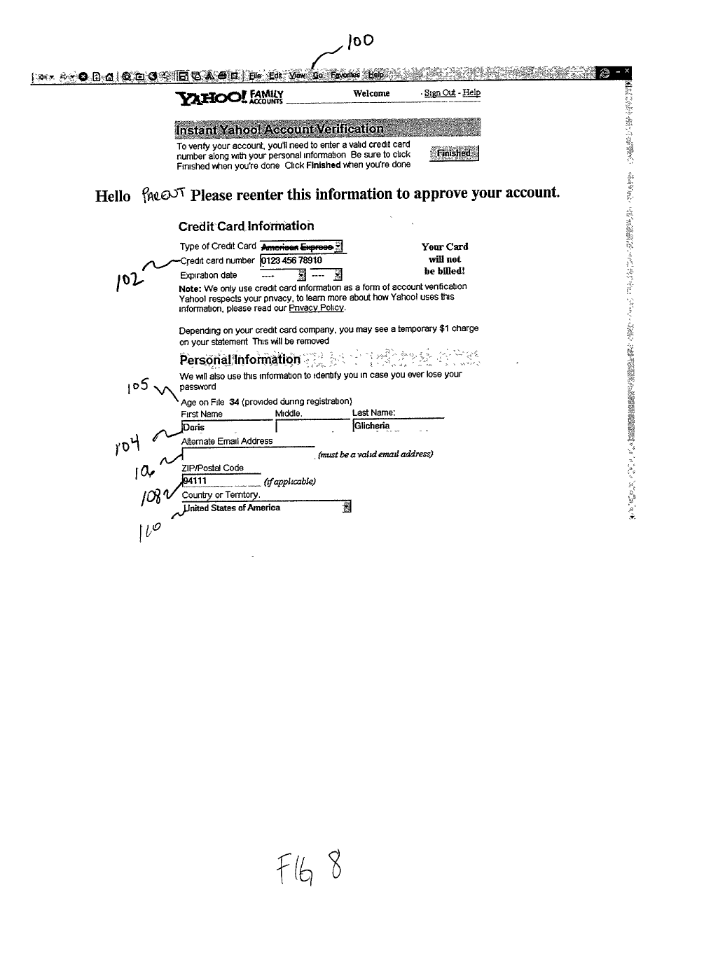

FIG. 8 depicts a user interface 100 presented to the user for verifying that the user is qualified to access and to modify the child accounts which are linked to the parent account. In a specific embodiment, a credit card number 102 and type are to be entered to verify that the user is above eighteen years old. Additional information might be used to secondarily verify that the user meets certain requirements to access the family account. For example, the user's name 104, alternate email address 106, zip code 108, country or territory 110, etc. might be used for such a purpose. The country 110 information might also be used to warn the user that certain content available in one country might not be available in another, due to differing cultural and legal standards. The entity providing the user account, such as Yahoo!, might restrict certain portions of its offering automatically in view of different laws of the country. Given this, the user might also be presented with the opportunity to override such automatic limitations. Age 105 indicates the present age of the user, as provided initially to the entity providing such accounts or during the set up of the family account.

With parental monitoring of child accounts, a parent thus links their personal account to an account of the child. By way of example, the parent might connect a browser to the Web address “family.yahoo.com” to set up a link. In one embodiment, the parent certifies to the system that the parent is over the legal age (18, or other legal age depending on jurisdiction) by entering a credit card number and credit card information. The parent thereby certifies that they are the parent of the child, and by when a child uses their password created by the parent, the child confirms the parent relationship.

When a parent creates a family account, the parent must verify their own account and show that they are over 18 and that the child maintaining a child account is a child of that parent. One way for a parent to verify his or her own account is to have the parent enter credit card information. The credit card will not be charged (unless the online service is a for-fee service), but will be authenticated through conventional authentication channels or their equivalent. Once a family account is created and the child account is associated with the family account, the child account is restricted in several ways, such as being excluded from some areas of the content databases 222 of FIG. 2 and being excluded from some content, services, etc. provided by the access provider.

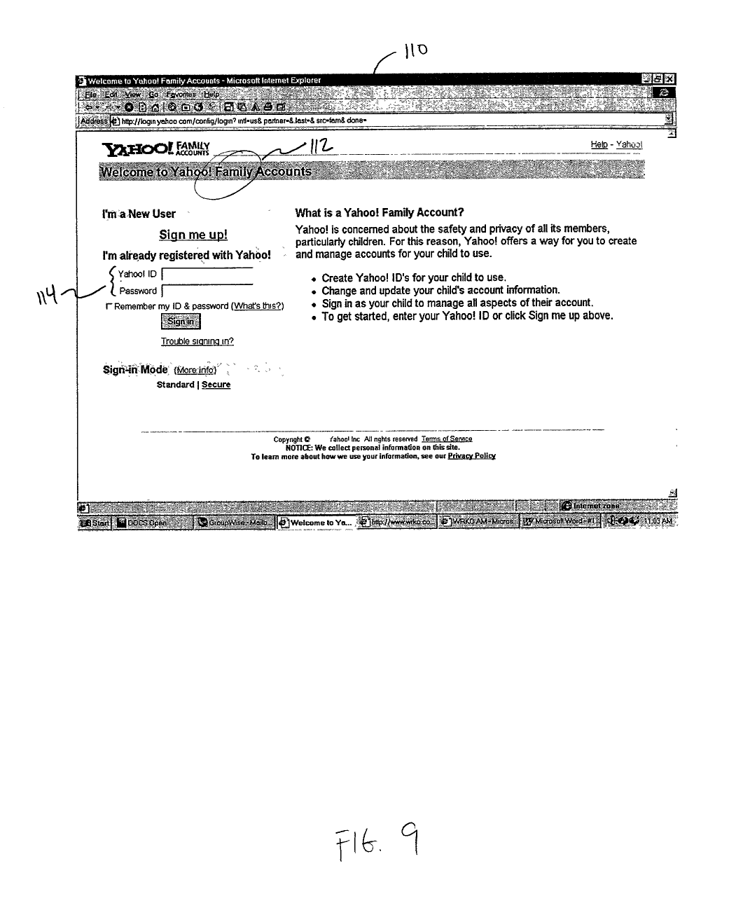

FIG. 9 illustrates a user interface 110 available to a user of a currently established user account to next establish a family account 112 for altering or for creating a new subservient, or child account. The user need only enter a user identifier (e.g., ID) and/or password 114. Once the user identifier successfully establishes its validity as user over eighteen years old and with its relationship with a child account, the user identifier might be used as the parent account holder's identifier as discussed above (i.e., parent identifier 54 of FIG. 3). In multi-parent controlled accounts, each of the parent account holders might have the same user identifier and/or password 114 as the other, or each holder might have their own identifier and/or password 114. Regardless, each of the holders of the parent accounts and their accounts will be linked accordingly to control the respective child accounts.

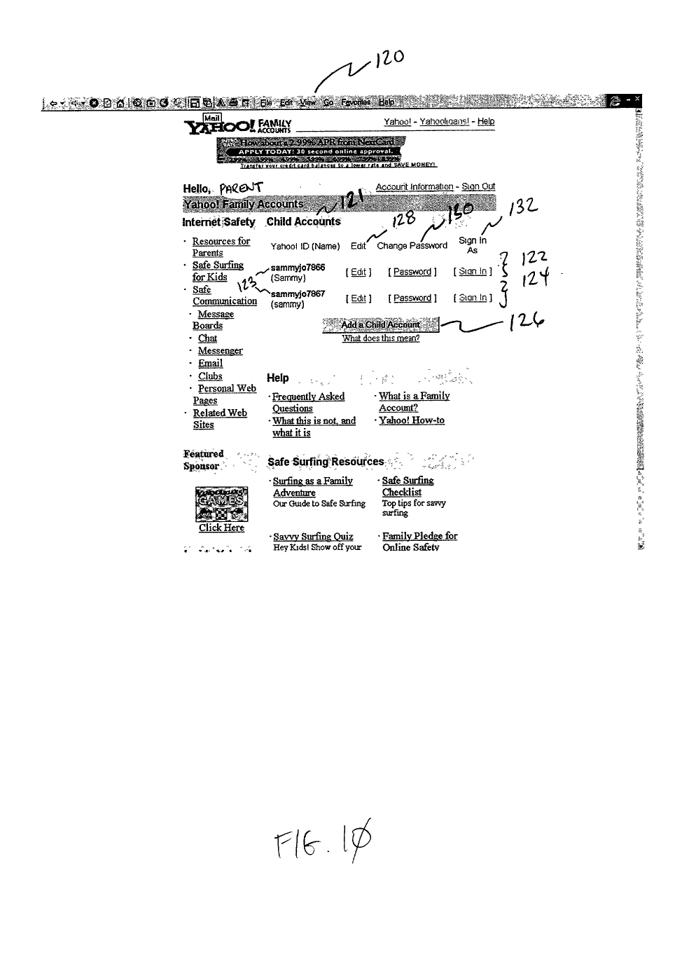

FIG. 10 shows a user interface 120 presented to the user to add, to delete or to modify one or more child accounts 122 and 124 linked to the parent account. Hence, in some implementations, a child account 121 might be associated with only one parent account and once a child account is so associated, no other parent account can be linked to the child account for monitoring. While this prevents unauthorized adults from gaining access to a child's account activity, it also precludes multiple parent oversight of the child's activity. In other implementations, multiple parent oversight might be accommodated by either allowing multiple parent accounts to be associated with one family account or by requiring that the parent that set up the initial link be the one to add new parent accounts to the family account. In the latter, a hierarchy from top-to-bottom includes a controlling parent in a first tier that grants a link to itself by other second tier parent accounts. Those second tier parent accounts thus also can exercise dominion over the third tiered child accounts. The second tier parent accounts and their holders, however, may be overridden by the controlling parent.

The authorized parent may add a child account 121 by selecting, or clicking on, “add a child account” 126. As shown in FIG. 10, two exemplary child accounts have been already established. That is, child account 122 has been created for a child associated with child identifier Sammyjo7866 and child account 124 has been created for a child associated with child identifier Sammyjo7867. The controlling parent of child accounts 122 and 124 might choose to edit each of the child's established account-specific information. A parent might edit a child's user identifier 123 if such identifier is too suggestive of an age, gender, etc. For example, if the child's identifier was established as “BarbieFriend_1293,” such an identifier might suggest a young female child as user, or a birth date of “Jan. 2, 1993.” An neutral identifier might be more appropriate, such as “Red234.” Account-specific information is information that describes, for example, the user, such as a name, age, address, etc. Such account-specific information is stored, for example, as data elements described above.

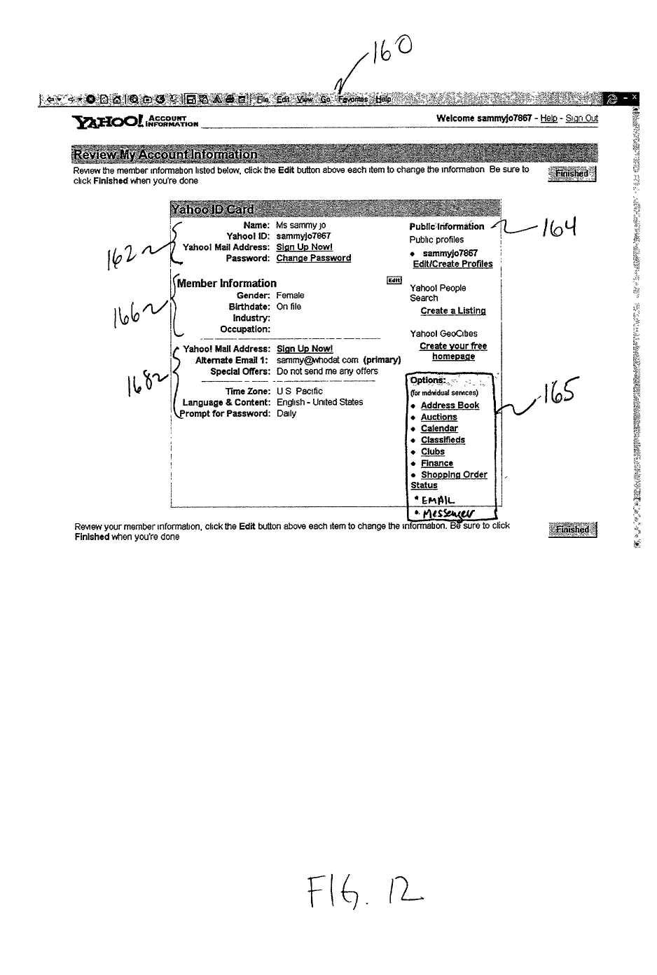

The controlling parent can change the password 130 of the child account and might also sign in as the child to monitor the child's email, access to other web sites, degree of exposure to inappropriate content, etc., which will be described in connection with FIG. 12.

In a specific embodiment, when a parent changes a child's password, the access system will send the affected child and associated child account an email confirmation. The child would then use the new password the next time they sign in to the access server. In some embodiments of an access server, the user of the child account is able to subsequently change the password, but the user of the parent account can continually update the preferences with a new password.

In effect, the parent creates a “family” account with the online access server 214 of FIG. 2. The server includes logic and data storage that allows the server to track account identifiers (IDs) for each child in the family. With the family account, a parent that controls the family account (the “controlling parent”) can add a child to the family account with a new child account, attaching an existing child account to the family account, modify a child's password, account information or other information (e.g., preferences, stored items) saved at the online system in association with a specific account, modify their child's email blacklists, friend “buddy” lists and instant message ignore lists, or sign in as the child in order to be aware of and modify any aspect of the child's account, as is described hereafter.

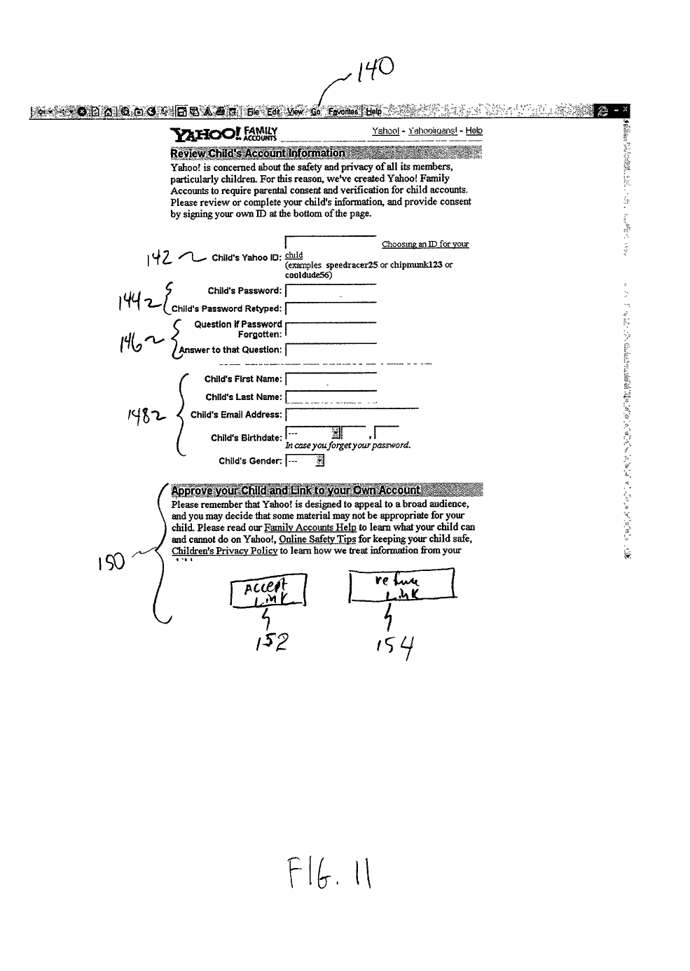

FIG. 11 depicts a user interface 140 presented to a user when either adding a new child account or editing the child account. The parent provides an appropriate child identifier 142 and child password 144, perhaps after consulting with the particular child. As an on-line secondary verification technique, a unique question and answer 146 can be provided (known only to the user or family account users). Child-specific information 148 is also entered by the parent. After the child account information has been prepared for submission, the parent can approve the child account and link it to the parent account 150. To accept a link, the parent chooses to accept a link 152. To delete a link, or to refuse a link, the parent might select such a selection 154.

FIG. 12 is an example of a user interface 160 that is presented to a parent that selects to sign on as a child 132 of FIG. 10. When a parent signs as a particular child, the parent has control over specific account information 162. That is, the parent may modify the child's identifier, name, password, etc. Also the parent may elect to grant a child account its own email access. If a parent chooses to permit the child account to receive email, the parent may select to enact one or more email block options. Email block options include blocking emails with inappropriate language, inappropriate attachments (i.e., JPEG files), unknown originating email addresses, spam emails, blocked email addresses, etc.

Also, the parent has access to modify characteristics of the child account, such as Member Information 166 and other child account specific information 168. Additionally, the controlling parent may limit the types or quantity of public information 164 that will be available to other account owners, for example, when the holder of a child account accesses a message board, a chatroom, or the like. Furthermore, the parent may limit, or permit full or no access to other areas of the child's account. The parent might select one or more options 165 to restrict the child account's access, for example, with respect to the child's “buddy list” of its messenger list.

In a specific embodiment, a holder of a child account is configured by an access server such that the holder cannot participate in any auction, and will not be permitted access to listings or participate in adult chatrooms, adult clubs and message boards, adult shopping areas, adult auction areas, or any other area that the adult deems inappropriate. In another specific embodiment, certain restrictions might be overridden by a controlling parent.

Therefore, according to the present invention, any single or multiple parent or family account holder (i.e., a parent in a family account) can perform actions on a child account in that same family, such as editing the child's account characteristics (e.g, account information), such as viewing and/or editing the child's public profiles, changing the child's password, editing the child's listing in directories maintained as part of content databases 222 of FIG. 2 (for example, Yahoo!'s People Search databases), or sign in as the child to view and/or edit the child's messaging buddy list, chat settings (such as language filter settings), email block lists and other personalized features.

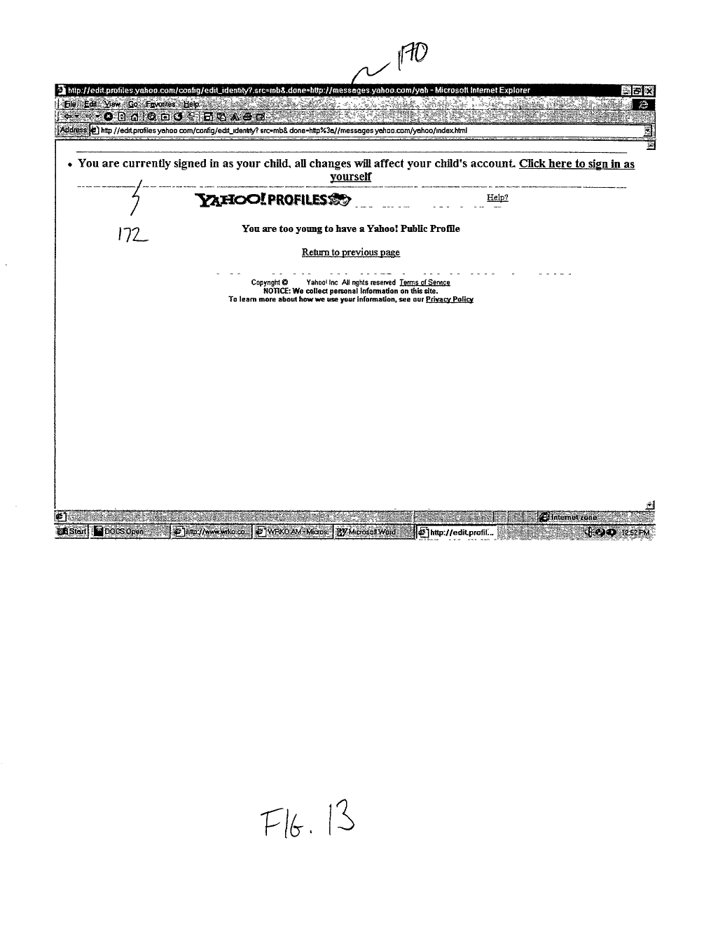

FIG. 13 illustrates a user interface 170 presented to either a parent signed in as a child, or the child itself, which indicates that the holder's use of the child account is limited. For example, children under a certain age, such as 12 years old, might not be allowed certain features, such as public profiles or directory listings. Other preferences a parent might be allowed to edit are preferences that indicate whether or not the child account will receive targeted email or special offers. Notice 172 reminds the controlling parent that the parent is currently signed into a child account so that inadvertent access is not made available to a child.

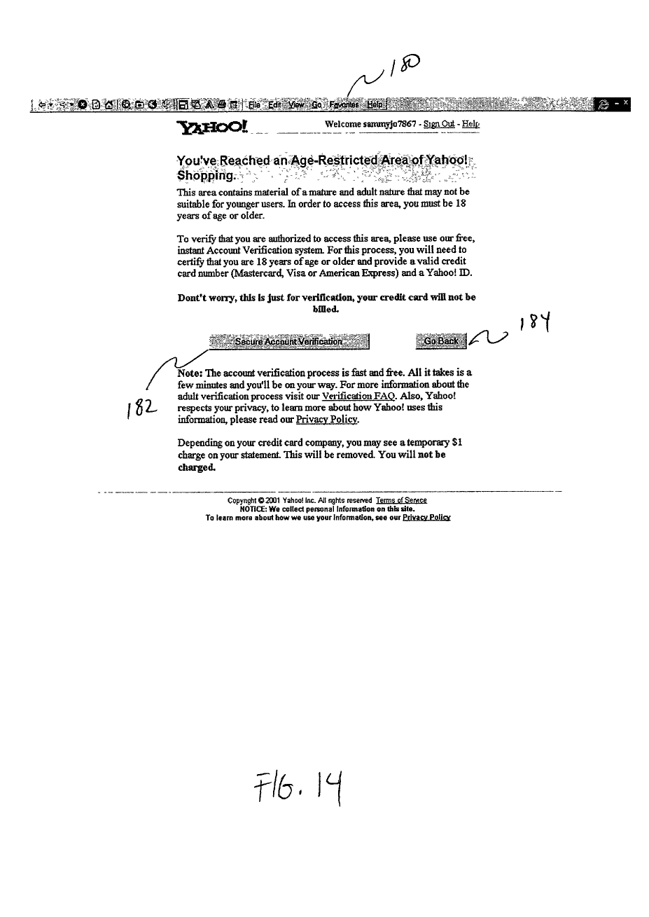

FIG. 14 shows a user interface 180 presented to a user of a child account who attempts to access, for example, age-restricted shopping content, or the like. The user of the child account then will have the opportunity to verify 182 that the associated account can access such shopping content. If the user knows that his or her access is limited, he or she can go back 184 to authorized sites, pages and/or content. In a specific embodiment, the child account stores such account access requests are available to the controlling parent for review to determine where or what type of areas the holder of the child account has attempted to gain access.

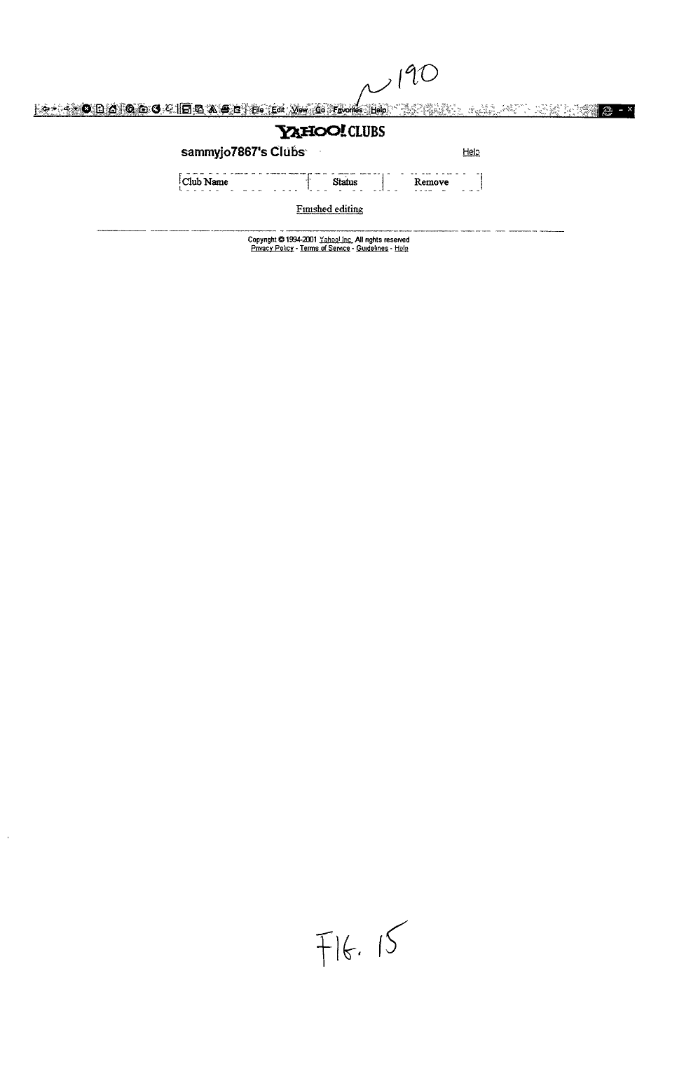

FIG. 15 illustrates a user interface 190 that a user of a child account will be presented with if the child attempts to access either a public message board or an exclusive message board, such as Yahoo! Clubs, that the account has not been given permission by a controlling parent. FIG. 15 shows that no clubs have been selected to be accessible to the subject child account identified as Sammyjo7867. If the parent signs in as a child and selects one or more appropriate message boards to be available to the child account, the user interface 190 will present only those authorized message boards. Similar to the child account's access to chatrooms, the parent may select to activate a language filter, such as a chat language filter or a message board language filter that blocks inappropriate words from being presented to the user of the child account.

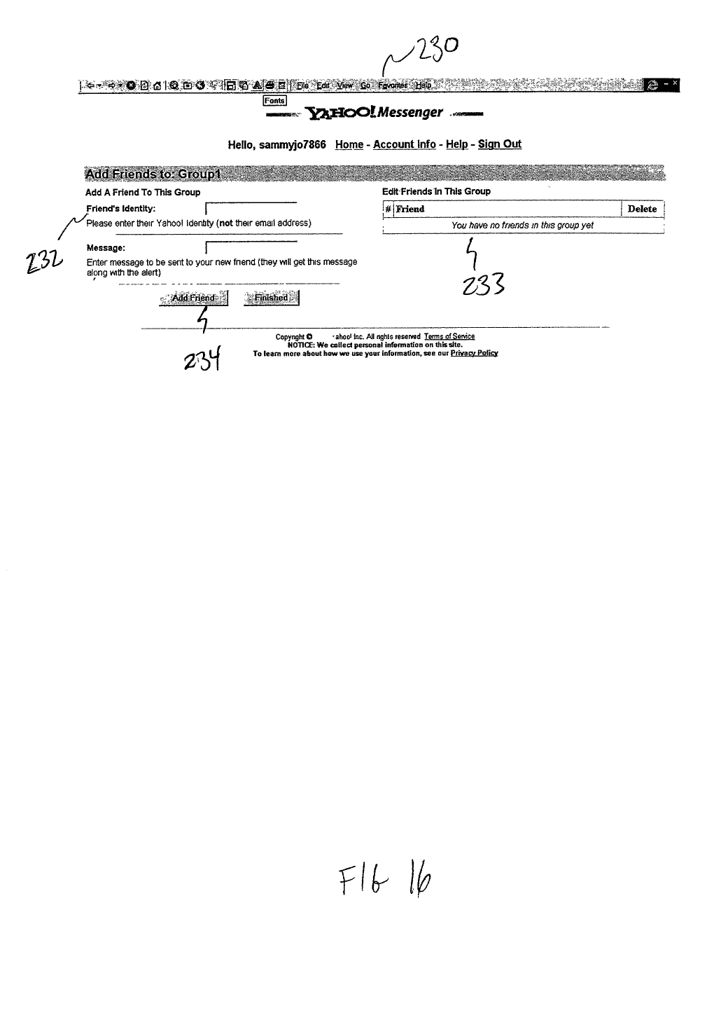

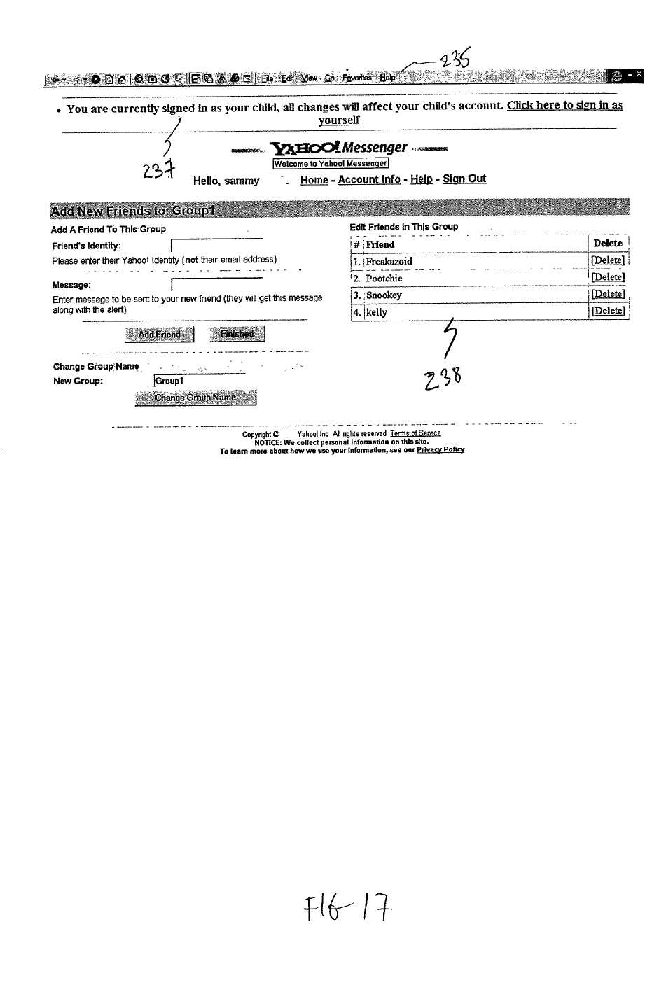

FIG. 16 and FIG. 17 show a user interface presenting to a user an Internet instant messaging service configuration page. User interface 230 of FIG. 16 is presented to a child account user who has been given no permission to contact friends (i.e., buddies) using the messaging service. User interface 230 is also present to a controlling parent. However, such a controlling parent is permitted to enter a friend's messenger identity 232 and to add such a friend 234 to a friend's group or buddy list 233.

FIG. 17 illustrates an exemplary user interface 235 presented to a parent signed in as a child 237, or to a holder of a child account wishing to use an Internet messaging service, such as Yahoo! Messenger. For example, after the parent has established a particular friend group 238 (i.e., buddy list), the only friends that may communicate (i.e., send and receive Internet messages to and from authorized friends) with the subject child account is Freakazoid, Pootchie, Snookey, and kelly, as shown in FIG. 17. No other account owner may communicate with the child account using such a messenger service. Thus, the child account holder is shielded from receiving inappropriate material or prevented from divulging personal information to unknown persons.

The present invention provides several methods in which to prevent underage children or other non-qualified personnel from obtaining an unrestricted user account with the service providing entity, such as Yahoo!. In one embodiment, as a user begins to set up an account, the user is required to specify his or her age. If the age is established as being less than some threshold, such as age 13, the access control system according to the present invention (e.g., access server) will require the user to link the new account to a family account, thereby requiring parental oversight.

In another embodiment, if a user attempts to set up an account with a falsified user age, the access control system triggers the requirement for a family account if the access control system determines that the user is in fact under the minimal acceptable age. When the access server detects that the user's account is not linked to a family account, the access server can then request that the user have a parent set up a family account. For example, the user applying a falsified user age must also provide account verification information similar to what is shown in FIG. 8. That is, the user must still certify that the user is of an appropriate age, such as providing a credit card number or other any means of identification.

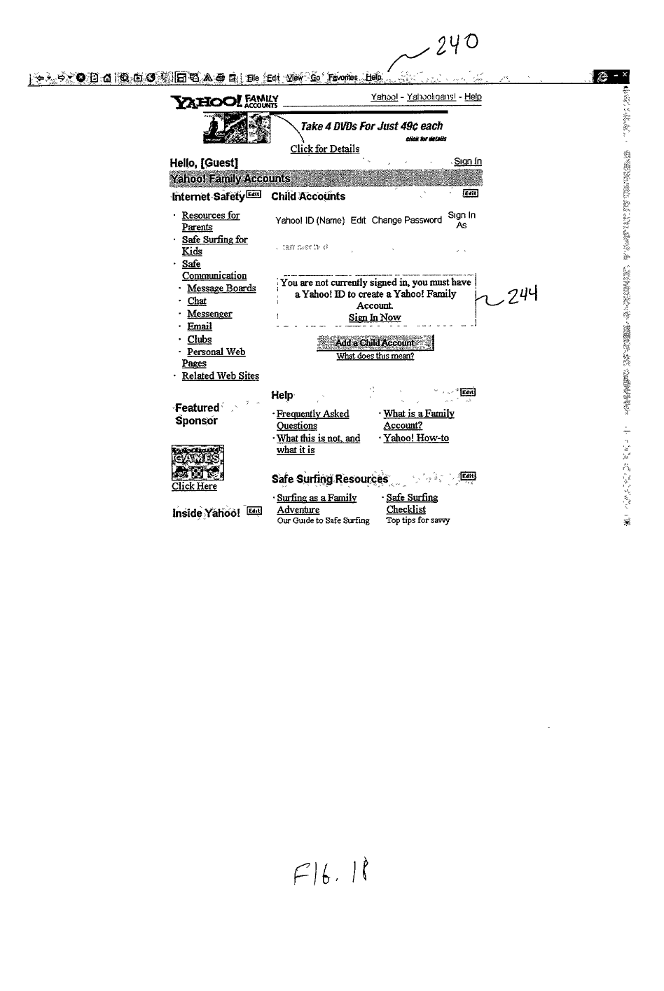

FIG. 18 illustrates an exemplary user interface 240 presented to a user of a child account who attempts to create a child account without first establishing a unrestricted account such as described above in connection with FIGS. 6, 7 and 8. The access control system responds with such an attempt by requesting the user to sign into the system 244 by providing a previously established account (e.g., parent account).

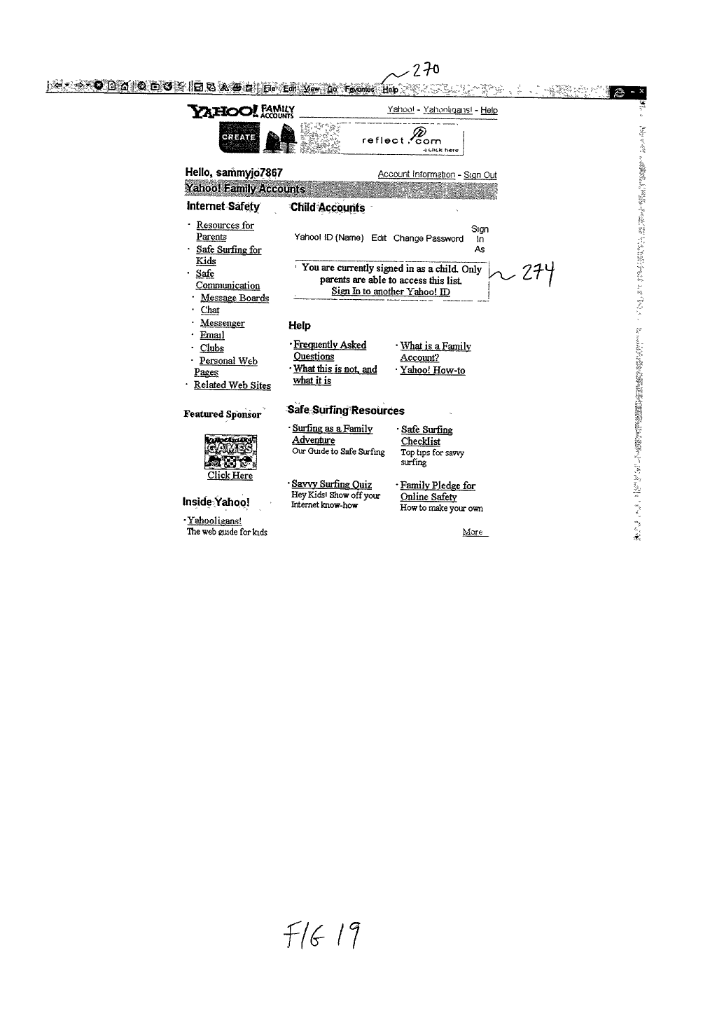

FIG. 19 shows an exemplary user interface 270 presented to a user of a child account who attempts to create a child account within an established a child account without first establishing itself as a parent account (i.e., unrestricted account to create a family account) such as described above in connection with FIG. 9. The access control system responds with such an attempt by notifying the user 274 of the child account that only by providing a previously established account (e.g., parent account).

In yet another embodiment, a method of detecting underage users uses secondary verification information and, for example, compare the contact information provided during the set up of a new account with contact information previously provided by previously established accounts owners. If the access control system detects that at least one previously established account contains information approximately similar to the information provided during the set up of the new account, then the system requires age validation. For example, if a user provides a name, address, telephone number and/or email address as account contact information and indicates that their age is less than 13 that account will be flagged as a child account. If another user later attempts to set up a new account with an age of 13 or over, but uses sufficient contact information in common with an existing child account, such as information 144 and 146 of FIG. 11 and information 162, 166 and 168 of FIG. 12, the access control system of the present invention will assume that the new user is the same as the user of the existing child account and will require parental oversight notwithstanding the falsified age entry. Hence, duplicative child accounts for the same child will be prevented, which avoids possible inconsistencies that might be exploited by a child to gain unauthorized access to inappropriate material.

It should be understood that the present invention relates to networks in general and need not be restricted to Internet data. Additionally, the present invention as described herein may be used in combination with means for Web Site filtering, such as provided by Net Nanny software of Net Nanny Software, Inc., Cyber Patrol software of Microsystems Software, Inc., Cybersitter software of Solid Oak Software, Inc., or the like. The scope of the invention is to be determined solely by the appended claims.

What is claimed is:

1. An apparatus for controlling use of services provided by an account based access server, the apparatus configured to communicate with a plurality of users where each of the users are associated with a user computing device, the apparatus comprising:
a user database having data representing a plurality of user accounts, wherein a user account is associated with at least one of the plurality of users;
a relational data structure to maintain a relationship between the user account and at least one other user account, the relational data structure including at least one user account identified as a parent account and at least one user account identified as a child account;
logic to verify parental status of the parent account with respect to the child account; and
logic to limit access to a user of the child account that is associated with the parent account, where such limitations are determined, at least in part, based on a selection made by a user of the parent account.

2. An apparatus of claim 1, wherein the relational data structure further includes a family account comprising the parent account and the child account.

3. An apparatus of claim 1, further comprising logic to allow the user of the parent account to access the child account.

4. An apparatus of claim 3, wherein the logic to allow the user of the parent account access further comprises logic to allow the user of the parent account to view web sites presented to the user of the child account.

5. An apparatus of claim 1, further comprising logic to prevent the user of the child account from establishing another child account having a relationship with the child account.

6. An apparatus of claim 1, further comprising logic to prevent the user of the child account from establishing another user account not associated with the parent account.

7. An apparatus of claim 2, further comprising logic to prevent the user of the child account from establishing another user account not associated with the family account.

8. An apparatus of claim 5, wherein the logic to prevent establishing another user account is configured to require the user of the child account to provide verification.

9. An apparatus of claim 8, wherein the logic to prevent establishing another user account is responsive to a child identifier.

10. An apparatus of claim 8, wherein the logic to prevent establishing another user account is responsive to a credit card number.

11. An apparatus of claim 1, wherein the logic to limit access is configured to block access to all resources by the user of the child account based on the selections.

12. An apparatus of claim 11, wherein the access blocked is based also on a first age range.

13. An apparatus of claim 12, wherein the first age range is under 13 years old.

14. An apparatus of claim 1, wherein the logic to limit access is configured to allow access to all resources by the user of the child account based on a selection made by a user of a parent account.

15. An apparatus of claim 1, wherein the logic to limit access is configured to allow access to a subset of all resources by the user of the child account based on the selections.

16. An apparatus of claim 15, wherein the access blocked is based on a second age range.

17. An apparatus of claim 16, wherein the second age range is 13 years old through and up to 18 years old.

18. An apparatus of claim 15, wherein the subset of all resources includes an instant messenger service with communications restricted to a friend list determined by a selection made by the user of the parent account.

19. An apparatus of claim 15, wherein the subset of all resources includes one or more chatrooms with communications restricted to filtered language as determined by a selection made by the user of the parent account.

20. An apparatus of claim 15, wherein the subset of all resources includes one or more non-blocked email addresses from communicating with the child account as determined by a selection made by the user of the parent account.

21. An apparatus of claim 15, wherein the subset of all resources includes one or more authorized shopping areas as determined by a selection made by the user of the parent account.

22. An apparatus of claim 15, wherein the subset of all resources includes one or more authorized clubs as determined by a selection made by the user of the parent account, where a club is a message board requiring membership.

23. An apparatus of claim 1, wherein the logic to limit access includes logic configured to allow the parent to modify an account characteristic used to define the child account.

24. An apparatus of claim 23, wherein the account characteristic modified is a public profile of the child account.

25. An apparatus of claim 23, wherein the account characteristic modified is a password of the child account.

26. An apparatus of claim 23, wherein the account characteristic modified is the child identifier of the child account.

27. An apparatus of claim 1, wherein the data structure is a link table.

28. An apparatus for controlling use of services provided by an account based access server, the apparatus configured to communicate with a plurality of users where each of the users are associated with a user computing device, the apparatus comprising:
a user database having data representing a plurality of user accounts, wherein a user account is associated with at least one of the plurality of users;
a relational data structure to maintain a relationship between the user account and at least one other user account, the relational data structure including at least one user account identified as a parent account and at least one user account identified as a child account;
logic to verify parental status of the parent account with respect to the child account; and
logic to permit one or more parent account access to the child account associated with the one or more parent account, based on a selection made by a user of the one or more parent accounts.

29. An apparatus of claim 28, wherein the logic to permit one or more parent account access is configured to allow access to only one parent account.

30. An apparatus of claim 28, wherein the logic to permit one or more parent account access is configured to allow access to at least two parent accounts.

31. An apparatus of claim 30, wherein the at least two parent accounts include at least one controlling parent account and at least one non-controlling parent account, wherein the controlling parent account is configured to override a selection made by the one non-controlling parent account.

32. A method for controlling a sub-account, the method using an access server coupled to a control account and a database, the access server configured to communicate with a user computer system executing a user interface operated by a human user and further configured to effect a modification of the sub-account, wherein the user interface includes a display device and a user input device, wherein the user computer system executing the user interface includes a processor and a memory coupled to the user interface, wherein the user computer system is coupled to a network for transferring information to the access server, the method comprising:
accepting signals from the user input device to access the sub-account associated with the control account;
presenting to the user of the control account one or more preferences, where the one or more preferences are associated with the sub-account;
selecting at least one preference; and
transferring information associated with the selected preference over the network to cause the sub-account to be modified.

33. The method of claim 32, wherein accepting signals from the user input device to access the sub-account includes determining that a predetermined control on the display device has been activated by the user.

34. The method of claim 33, wherein the display device displays a web page, wherein the predetermined control is a button on the web page.

35. The method of claim 32, wherein accepting signals from the user input device to access the sub-account comprises accepting signals from the user input device to access the control account.

36. The method of claim 35, wherein the sub-account is responsive to signals including a text command.

37. The method of claim 35, wherein the sub-account is responsive to signals including a voice command.

38. The method of claim 32, wherein the at least one selected preference includes a subset of all resources available to the sub-account.

39. The method of claim 32, wherein the at least one selected preference includes an account characteristic.

40. The method of claim 32, wherein the at least one selected preference is configured to allow only one control account to access the sub-account.

41. The method of claim 32, wherein the at least one selected preference is configured to allow another control account to access the sub-account.

42. The method of claim 41, wherein the control account controls the another control account.

43. The method of claim 32, further comprising adding another sub-account, wherein adding another sub-account includes:
creating a new sub-account by using the user interface; and
linking the new sub-account to the control account,
wherein the new sub-account is configured to limit access to a user of the new sub-account account that is associated with a family account, where such limitations are determined, at least in part, based on the selected preference made by a user of the control account associated with the family account.

44. The method of claim 43, wherein creating a new sub-account comprises:
determining that a prior sub-account has not been established for the user of the new sub-account; and
verifying that the control account used to establish the new sub-account is authorized to do so.

45. A method for preventing creation of an unrestricted user account by an unauthorized user, the method using an access server coupled with a database, the access server configured to communicate with a user computer system executing a user interface operated by a human user and further configured to detect an unauthorized attempt to create the unrestricted account, wherein the user interface includes a display device and a user input device, wherein the user computer system executing the user interface includes a processor coupled to the user interface, wherein the user computer system is coupled to a network for transferring information to the access server, the method comprising:
accepting signals from the user input device to determine if a user meets at least one minimum requirement;
determining that the user fails to meet the at least one minimum requirement;
accepting signals from the user input device to verify that the at least one minimum requirement is met;
determining that the at least one minimum requirement of the user has not been verified;
accepting signals from the user input device to determine that the user is associated with a sub-account;
determining that the user is associated with a sub-account; and
denying formation of the new unrestricted account.

46. The method of claim 45, further comprising:
determining that a control account is associated with the unauthorized user; and
indicating to a holder of the control account that the unauthorized attempt to create the new unrestricted account has been detected.

47. The method of claim 45, wherein determining that the user fails to meet the at least one minimum requirement includes determining whether a user age meets at least a minimum age.

48. The method of claim 45, wherein determining that the at least one minimum requirement of the user has not been verified includes providing a credit card number.

49. The method of claim 45, wherein determining that the user is associated with a sub-account includes using secondary verification information to prevent creating a duplicative sub-account for the user.

50. The method of claim 49, wherein the secondary verification information includes account specific information.

51. An apparatus for controlling use of services in an account based access server, the apparatus configured to communicate with a plurality of users where each of the users are associated with a user computing device, the apparatus comprising:
means for accessing data, the data representing a plurality of user accounts, wherein a user account is associated with at least one of the plurality of users;
means for maintaining a relationship between the user account and at least one other user account, wherein the relationship includes at least one user account identified as a parent account and at least one user account identified as a child account;
means for verifying parental status of the parent account with respect to the child account; and
means for limiting access to a user of the child account that is associated with the parent account, where such limitations are determined, at least in part, based on a selection made by a user of the parent account.

52. An apparatus for controlling use of services in an account based access server, the apparatus configured to communicate with a plurality of users where each of the users are associated with a user computing device, the apparatus comprising:
means for accessing data, the data representing a plurality of user accounts, wherein a user account is associated with at least one of the plurality of users;
means for maintaining a relationship between the user account and at least one other user account, wherein the relationship includes at least one user account identified as a parent account and at least one user account identified as a child account;
means for verifying parental status of the parent account with respect to the child account; and
means for permitting one or more parent access to the child account associated with the one or more parent account, based on a selection made by a user of a parent account.

53. A method for controlling a sub-account, the sub-account is configured to have limited user access to resources provided by a content manager, wherein the access to the content is controlled by a control account, the method comprising:
accessing the control account;
accessing the sub-account associated with the control account;
providing to the user of the control account one or more preferences;
associating at least one preference with the sub-account; and
modifying the sub-account according to the information associated with the at least one preference.

54. The method of claim 53, further comprising a step for adding another sub-account, wherein adding another sub-account includes:
creating a new sub-account;
determining that a prior sub-account has not been established for the user of the new sub-account;
verifying that the control account used to establish the new sub-account is authorized to do so; and
linking the new sub-account to the control account such that the control account controls the another new sub-account.

55. A computer data signal embodied in a carrier wave, wherein the computer data signal is used to control a sub-account, the sub-account being configured to have limited user access to content, wherein the access to the content is controlled by a control account, the computer data signal comprising:
program code to access the control account;
program code, responsive to the control account, to access the sub-account associated with the control account;
program code to provide to the user of the control account one or more preferences;
program code to associate at least one preference with the sub-account; and
program code to modify the sub-account responsive to the information associated with the at least one preference.
